(19) United States
(12) Patent Application Publication
(10) Pub. No.: US 2005/0243251 A1
(43) Pub. Date: Nov. 3, 2005

(54) Transflective liquid crystal display with bent electrodes

(75) Inventors: Chiu-Lien Yang, Miao-Li (TW); Jia-Pang Pang, Miao-Li (TW); Chueh-Ju Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/120,426

(22) Filed: May 2, 2005

(30) Foreign Application Priority Data
Apr. 30, 2004 (TW) 93112187

(51) Int. Cl. G02F 1/1335

(52) U.S. Cl. 349/114; 349/141

(57) ABSTRACT

A transflective liquid crystal display (2) includes a transparent upper substrate (100), a lower substrate (200) opposite to the upper substrate, a liquid crystal layer (300) sandwiched between the two substrates, gate lines (170) and data lines (180) defining pixel units arranged in a matrix, pixel electrodes (210) and common electrodes (220) associated with one of the substrates to each pixel unit of one of the substrates, a transflective layer (250) formed at one side of one of the substrates. The pixel electrodes and the common electrodes have the same bent form, are disposed alternately, and are substantially parallel to each other. When a voltage is applied on the electrodes, an electric field in two directions is generated. Liquid crystal molecules of the liquid crystal layer are oriented in two directions in accordance with the electric field. Therefore, color shift is reduced.

### BACKGROUND

1. Field of the Invention

The present invention relates to a liquid crystal display, and particularly to a transflective type IPS LCD (in-plane switching liquid crystal display).

2. General Background

In a liquid crystal display, a pair of transparent electrodes is respectively formed on each of two substrates, and is used for driving a liquid crystal layer between the substrates. In a typical such device, a displaying means known as a TN (twisted nematic) display is adopted. That is, the liquid crystal display operates by being supplied with an electric field having a direction orthogonal to inner the surfaces of the substrates.

However, the liquid crystal molecules adjacent to the substrate cannot be oriented perpendicular to the substrate when an electric field is applied. Further, the tilt angles of the liquid crystal molecules tend to differ. When a user observes the display from different directions, different display performances are obtained. This is the reason why a TN mode LCD is generally regarded as having a narrow viewing angle. In order to obtain a wide viewing angle, the IPS (in-plane switching) type LCD has been developed.

FIG. 9 is a schematic, side cross-sectional view of part of a conventional transflective type IPS LCD. The LCD 1 includes an upper substrate 10, a lower substrate 11 opposite to the upper substrate 10, and a liquid crystal layer 30 sandwiched therebetween. The liquid crystal layer 30 comprises a plurality of liquid crystal molecules. An upper alignment layer 40 is formed at an inner side of the upper substrate 10. A transflective layer 50, an insulation layer 60 and a lower alignment 41 are formed in sequence at an inner side of the lower substrate 11. Common electrodes 12 and pixel electrodes 13 are formed between the transflective layer 50 and the insulation layer 60. A pair of upper and lower polarizers 20, 21 is formed at outer sides of the substrates 10, 11, respectively.

The structure of the common electrodes 12 and the pixel electrodes 13 is generally comb-shaped. When a voltage is applied on the electrodes 12, 13, an electric field substantially parallel to the upper substrate 10 is generated by the electrodes 12, 13. The liquid crystal molecules are oriented to have the same direction as that of the electric field. The electrodes 12, 13 are made of a highly reflective material to reflect light.

Unlike the conventional TN type display, the common electrodes 12 and the pixel electrodes 13 of the IPS type LCD display are located on the same substrate, and an electric field substantially parallel to the lower substrate 11 is generated when a voltage is applied. The liquid crystal molecules are switched in a plane parallel to the lower substrate 10. This improves the response speed of the liquid crystal molecules, and provides a wide view angle for the liquid crystal display.

However, the pixel electrodes and common electrodes of the conventional IPS type LCD display are rectilinear and oriented in a single direction only, which means that all the liquid crystal molecules are rotated to be oriented in a single direction only. As a result, when an associated display screen is obliquely viewed while displaying white, the display screen exhibits color shift.

What is needed, therefore, is an LCD which reduces color shift.

### SUMMARY

One preferred embodiment provides a transflective liquid crystal display, comprising a transparent upper substrate, a lower substrate opposite to the upper substrate, a liquid crystal layer sandwiched between the two substrates, a plurality of gate lines and data lines defining pixel units arranged in a matrix, a plurality of pixel electrodes and a plurality of common electrodes associated with one of the substrates at each pixel unit of said one of the substrates. The pixel electrodes and the common electrodes have substantially the same bent form, are disposed alternately, and are substantially parallel to each other.

Because the pixel electrodes and common electrodes are bent, when a voltage is applied on the electrodes, an electric field in two directions is generated. Liquid crystal molecules of the liquid crystal layer are oriented in two directions in accordance with the electric field. Therefore, any color shift observed by viewing the transflective liquid crystal display from different directions is reduced, and a better display performance is attained.

Other objects, advantages, and novel features will become more apparent from the following detailed description when taken in conjunction with the accompanying drawings, in which:

### BRIEF DESCRIPTION OF THE DRAWINGS

FIG. 1 is a schematic, cross-sectional view of part of a transflective liquid crystal display according to a first preferred embodiment of the present invention;

FIG. 2 is a top plan view of a pixel region of the transflective liquid crystal display of the first preferred embodiment;

FIG. 3 is a schematic, cross-sectional view of part of a transflective liquid crystal display according to a second preferred embodiment of the present invention;

FIG. 4 is a top plan view of a pixel region of the transflective liquid crystal display of the second preferred embodiment;

FIG. 5 is a schematic, cross-sectional view of part of a transflective liquid crystal display according to a third preferred embodiment of the present invention;

FIG. 6 is a top plan view of a pixel region of the transflective liquid crystal display of the third preferred embodiment;

FIG. 7 is a schematic, inverted, cross-sectional view of a transflective layer and a lower substrate of the transflective liquid crystal display of the third preferred embodiment;

FIG. 8 is a schematic, cross-sectional view of part of a transflective liquid crystal display in accordance with a fourth preferred embodiment of the present invention; and

FIG. 9 is a schematic, cross-sectional view of part of a conventional liquid crystal display.

### DETAILED DESCRIPTION OF THE PREFERRED EMBODIMENTS

Reference will now be made to the drawings to describe the preferred embodiments in detail.

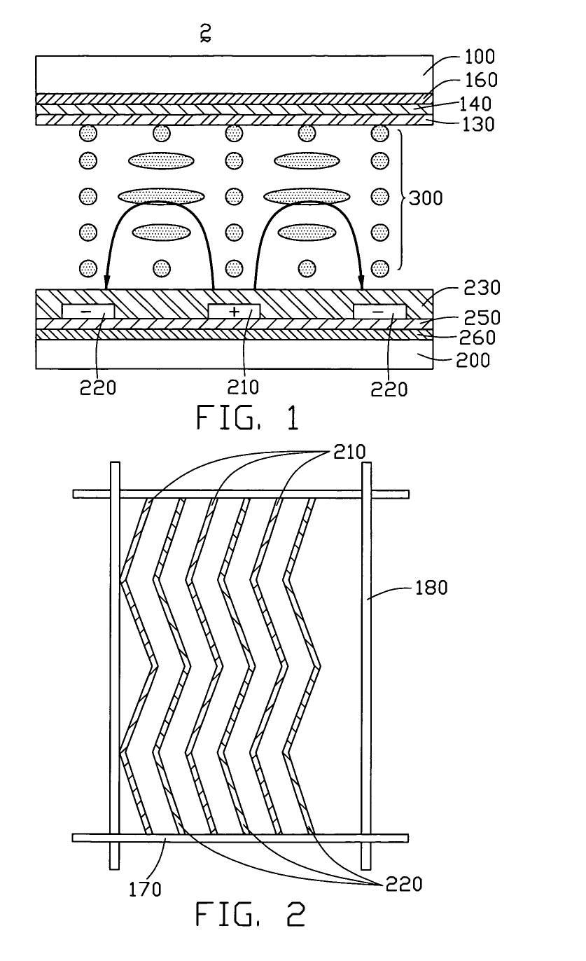

FIG. 1 is a schematic, cross-sectional view of part of a transflective liquid crystal display according to a first preferred embodiment. The transflective liquid crystal display 2 includes an upper substrate 100, and a lower substrate 200 opposite to the upper substrate 100. A liquid crystal layer 300 is sandwiched between the substrates 100, 200. An upper polarizer 160, a color filter 140 and an upper alignment film 130 are formed in sequence at an inner side of the upper substrate 100. A lower polarizer 260, a transflective layer 250 and a lower alignment 230 are formed in sequence at an inner side of the lower substrate 200. A plurality of pixel electrodes 210 and common electrodes 220 is formed between the transflective layer 250 and the lower alignment 230.

The pixel electrodes 210 and the common electrodes 220 are located on the transflective layer 250. The transflective layer 250 includes a plurality of reflective regions and transmission regions, and the structures and sizes of the reflective regions and transmission regions are variable according to the needs of any particular application.

Referring to FIG. 2, this is showing a top plane view of a pixel region of the transflective liquid crystal display 2. The transflective liquid crystal display 2 includes a plurality of gate lines 170 and a plurality of data lines 180, thereby defining a plurality of pixel regions formed at the crossings of the data lines 180 and the gate lines 170. The pixel electrodes 210 and the common electrodes 220 have the same rectilinearly bent shape, and are arrayed alternately. The pixel electrodes 210 and the common electrodes 220 are formed at a same level.

Because the pixel electrodes 210 and common electrodes 220 are bent, when a voltage is applied on the electrodes 210, 220, an electric field in two directions is generated. Liquid crystal molecules of the liquid crystal layer 300 are oriented in two directions in accordance with the electric field. Therefore, any color shift observed by viewing the transflective liquid crystal display 2 from different directions is reduced, and a better display performance is attained.

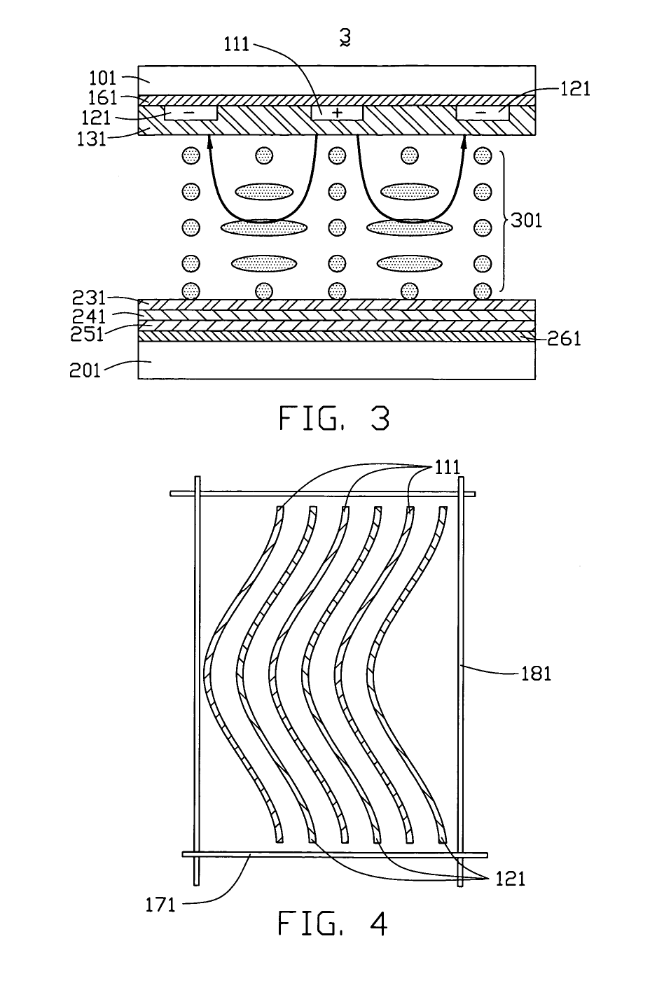

Referring to FIG. 3, this is a schematic, cross-sectional view of part of a transflective liquid crystal display according to a second preferred embodiment. The transflective liquid crystal display 3 includes an upper substrate 101, and a lower substrate 201 opposite to the upper substrate 101. A liquid crystal layer 301 is sandwiched between the substrates 101, 201. An upper polarizer 161 and an upper alignment film 131 are formed in sequence at an inner side of the upper substrate 101. A plurality of pixel electrodes 111 and a plurality of common electrodes 121 are formed between the upper polarizer 161 and the upper alignment film 131. A transflective layer 251, a color filter 241 and a lower alignment film 231 are formed in sequence at an inner side of the lower substrate 201.

FIG. 4 is a top plane view of a pixel region of the transflective liquid crystal display 3. The transflective liquid crystal display 3 includes a plurality of gate lines 171 and a plurality of data lines 181, and thereby defines a plurality of pixel regions between crossings of the data lines 181 and the gate lines 171. The pixel electrodes 111 and common electrodes 121 are wave-shaped, and arrayed alternately. The pixel electrodes 111 and common electrodes 121 are formed at a same level.

In contrast with the first embodiment, the pixel electrodes 111 and common electrodes 121 are formed on the upper substrate 101 and the color filter 241 is formed on the lower substrate 201. Because the pixel and common electrodes 111, 121 are wave-shaped with smooth bends, disclination such as that which may occur at elbow portions of the electrodes 210, 220 of the first embodiment can be avioded.

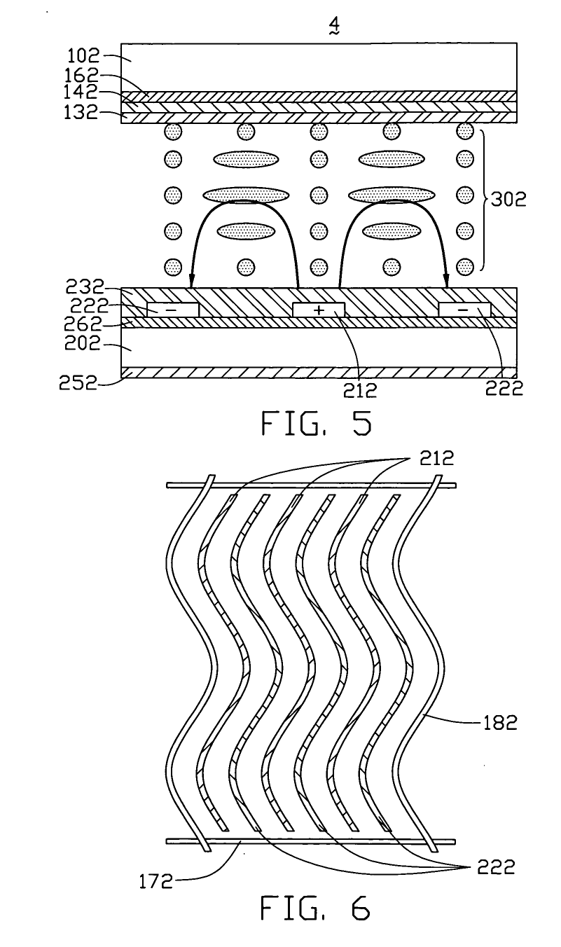

FIG. 5 is a schematic, cross-sectional view of a transflective liquid crystal display according to the third preferred embodiment of the present invention. The transflective liquid crystal display 4 includes an upper substrate 102, and a lower substrate 202 opposite to the upper substrate 102. A liquid crystal layer 302 is sandwiched between the substrates 102, 202. An upper polarizer 162, a color filter 142 and an upper alignment film 132 are formed in sequence at an inner side of the upper substrate 102. A lower polarizer 262 and a lower alignment 232 are formed in sequence at an inner side of the lower substrate 202. A transflective layer 252 is formed at an outer side of the lower substrate 202. A plurality of pixel electrodes 212 and a plurality of common electrodes 222 are formed between the lower polarizer 262 and the lower alignment 232.

FIG. 6 is a top plane view of a pixel region of the transflective liquid crystal display 4. The transflective liquid crystal display 4 includes a plurality of gate lines 172 and a plurality of data lines 182, with a plurality of pixel regions being defined between crossings of the data lines 182 and the gate lines 172. The pixel electrodes 212 and common electrodes 222 are wave-shaped, and arrayed alternately. The data lines 182 are also wave-shaped, so that they are parallel to the pixel and common electrodes 212, 222.

FIG. 7 shows a schematic, inverted, cross-sectional view of the transflective layer 252 and the lower substrate 202 of the liquid crystal display 4. The transflective layer 252 comprises several layers of transflective films. Each transflective films includes a plurality of protrusions 2521. However, the transflective films are parallel to each other throughout.

Unlike in with the first and second embodiments, the transflective layer 252 is formed at the outer side of its lower substrate 202. Further, the data lines 182 are parallel to the electrodes 212, 222, so that a nonfunctional area within each pixel region is smaller than that of each of the first and second embodiments. The protrusions 2521 of the transflective layer 252 can reduce mirror reflection. Thus the performance of the liquid crystal display 4 is improved.

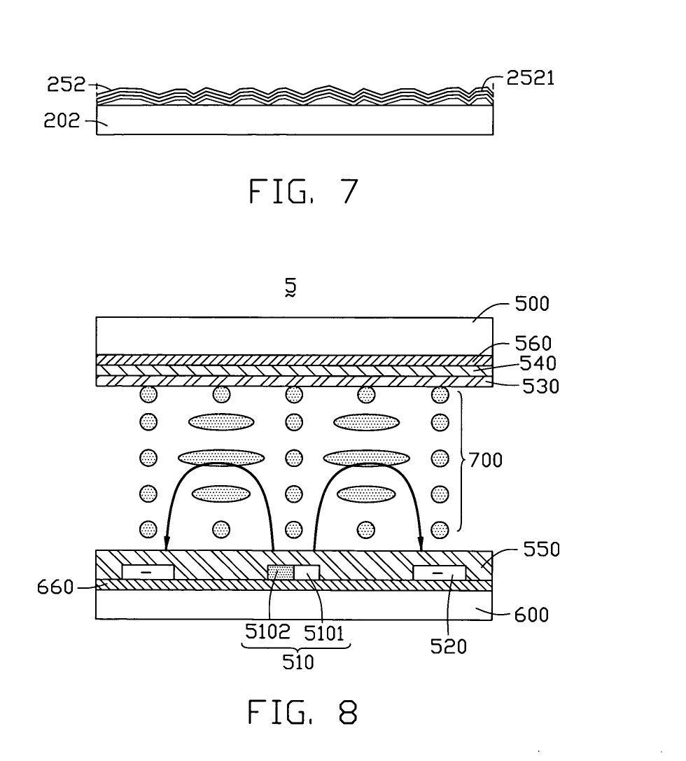

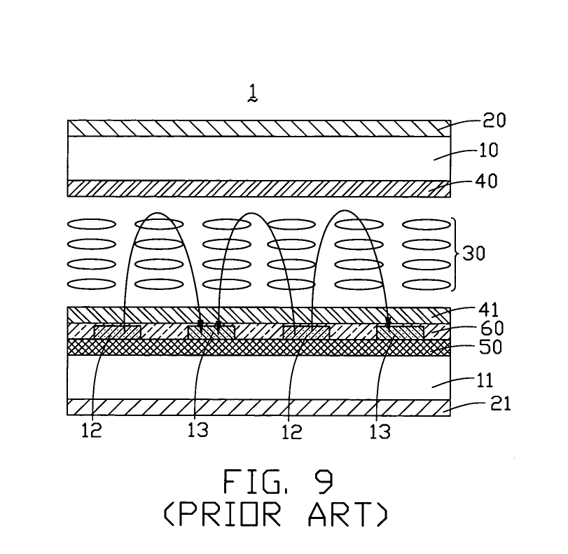

FIG. 8 is a schematic, cross-sectional view of part of a transflective liquid crystal display in accordance with the fourth preferred embodiment. The liquid crystal display 5 includes an upper substrate 500, and a lower substrate 600 opposite to the upper substrate 500. A liquid crystal layer 700 is sandwiched between the substrates 500, 600. An upper polarizer 560, a color filter 540 and an upper alignment film 530 are formed in sequence at an inner side of the upper substrate 500. A lower polarizer 660 and a lower alignment 550 are formed in sequence at an inner side of the lower substrate 600. A plurality of pixel electrodes 510 and a plurality of common electrodes 520 are formed between the lower polarizer 660 and the lower alignment film 550. Each pixel electrodes 510 includes a transmission electrode portion 5101 and a reflective electrode portion 5102. The pixel electrodes 510 and common electrodes 520 are formed at a same level. The pixel electrodes 510 and common electrodes 520 may be shaped according to any of the shapes of the pixel and common electrodes described above in relation to the first through third embodiments.

Many modifications and variations are possible within the ambit of the invention herein. For example, the pixel electrodes and common electrodes may be formed at different levels and/or on different layers respectively, with an isolation layer interposed between the pixel electrodes and common electrodes. Either of both polarizers may be an E-type polarizer. The E-type polarizer is different from a conventional O-type polarizer, because extraordinary waves can pass through the E-type polarizer. Light-leakage is reduced, and the width of the viewing angle of the liquid crystal display is improved.

It is to be understood, however, that even though numerous characteristics and advantages of the preferred embodiments have been set out in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A transflective liquid crystal display, comprising:
a transparent upper substrate;
a lower substrate opposite to the upper substrate;
a liquid crystal layer sandwiched between the two substrates;
a plurality of gate lines and data lines defining pixel units arranged in a matrix;
a plurality of pixel electrodes and a plurality of common electrodes associated with one of the substrates at each pixel unit of said one of the substrates, wherein the pixel electrodes and the common electrodes have substantially the same bent form, are disposed alternately, and are substantially parallel to each other.

2. The transflective liquid crystal display as claimed in claim 1, wherein the pixel electrodes and common electrodes have a rectilinearly bent shape.

3. The transflective liquid crystal display as claimed in claim 1, wherein the pixel electrodes and common electrodes are wave-shaped.

4. The transflective liquid crystal display as claimed in claim 1, further comprising a transflective layer formed at one side of one of the substrates.

5. The transflective liquid crystal display as claimed in claim 4, wherein the transflective layer comprises protrusions.

6. The transflective liquid crystal display as claimed in claim 4, wherein the transflective layer is at an outside of said one of the substrates.

7. The transflective liquid crystal display as claimed in claim 1, wherein each of the pixel electrodes includes a transmission electrode portion and a reflective electrode portion.

8. The transflective liquid crystal display as claimed in claim 1, wherein a shape of the data lines is similar to that of the pixel electrodes and common electrodes.

9. The transflective liquid crystal display as claimed in claim 1, further comprising a polarizer located at the inner side of one of the substrates.

10. The transflective liquid crystal display as claimed in claim 9, wherein the polarizer is an E-type polarizer.

11. A transflective liquid crystal display, comprising:
a transparent upper substrate;
a lower substrate opposite to the upper substrate;
a liquid crystal layer disposed between the two substrates;
a plurality of gate lines and data lines defining pixel units arranged in a matrix; and
pixel electrodes and common electrodes disposed parallel to each other at one of the substrates, each of the pixel electrodes and common electrodes being bent and comprising a first section and a second section, the first section being symmetrical to the second section.

12. The transflective liquid crystal display as claimed in claim 11, wherein the pixel electrodes and the common electrodes have a rectilinearly bent shape.

13. The transflective liquid crystal display as claimed in claim 11, wherein the pixel electrodes and common electrodes are wave-shaped.

14. The transflective liquid crystal display as claimed in claim 11, further comprising a transflective layer formed at one side of one of the substrates.

15. The transflective liquid crystal display as claimed in claim 14, wherein the transflective layer comprises protrusions.

16. The transflective liquid crystal display as claimed in claim 14, wherein the transflective layer is at an outside of said one of the substrates.

17. The transflective liquid crystal display as claimed in claim 11, wherein each of the pixel electrodes includes a transmission electrode portion and a reflective electrode portion.

18. The transflective liquid crystal display as claimed in claim 11, wherein a shape of the data lines is similar to that of the pixel electrodes and common electrodes.

19. The transflective liquid crystal display as claimed in claim 1, wherein liquid crystals in the liquid crystal layer are dimensioned differently.

20. The transflective liquid crystal display as claimed in claim 19, wherein the crystals located in a middle area is larger than those in a boundary area close to the substate.
